(19) United States
(12) Patent Application Publication
(10) Pub. No.: US 2002/0068186 A1
(43) Pub. Date: Jun. 6, 2002

(54) Painted exterior vehicle components comprised of high flexural modulus thermoplastics

(76) Inventors: Willem G. Tekelenburg, Bryan, OH (US); Theodore S. Barrie, Dearborn, MI (US)

Correspondence Address: Gerald E. McGlynn, III, Bliss McGlynn & Nolan, P.C., Suite 600, 2075 West Big Beaver Road, Troy, MI, 48084, US

(21) Appl. No.: 09/965,505

(22) Filed: Sep. 27, 2001

Related U.S. Application Data
(60) Provisional application No. 60/235,829, filed on Sep. 27, 2000.

(51) Int. Cl. B32B 27/00

(52) U.S. Cl. 428/500

(57) ABSTRACT

Paintable, exterior vehicle components comprised of high flexural modulus thermoplastic polyolefins, and methods for forming same, are described. The thermoplastic polyolefins preferably include polypropylene-based thermoplastic polyolefins having less than 20 weight percent of an elastomer, such as but not limited to ethylene-octene copolymers, and are characterized by a flexural modulus equal to or greater than about 110,000 pounds per square inch.

### CROSS-REFERENCE TO RELATED APPLICATION

The instant application claims priority to U.S. Provisional Patent Application Serial Number 60/235,829, filed Sep. 27, 2000, the entire specification of which is expressly incorporated herein.

### FIELD OF THE INVENTION

The present invention relates to paintable exterior body components for vehicles, such as, but not limited to, automobiles, and more particularly to such components formed from polypropylene-based thermoplastic polyolefins having an elastomer content of less than 20 weight percent, and characterized by a relatively high flex modulus equal to or greater than about 110,000 pounds per square inch.

### BACKGROUND OF THE INVENTION

Thermoplastic components form a significant part of many everyday durable products, most notably virtually every mass-produced automobile on the market today. Such polymer components include interior elements, for instance dashboards, as well as exterior elements, such as body panels, running boards, bumper fascias, grills, and the like. In exterior applications particularly, it is important that these thermoplastic components meet certain design and safety specifications typically mandated by governmental regulatory agencies.

For example, it is common practice in the automotive industry to employ various thermoplastic materials in manufacturing contact parts, such as bumpers, wherein the components are painted a desired color to match or complement the rest of the vehicle color. In order that low speed collisions not destroy these components, leading to costly repair or replacement, it is desirable that thermoplastic contact parts be sufficiently durable to withstand collisions without breaking, while further having the capacity to deform to a certain degree and thereafter assume their desired shapes again.

It is further desirable that any exterior, painted thermoplastic vehicle components have suitable durability in a variety of environments, because automobiles are driven in various climates, ranging from hot, tropical conditions to arctic environments.

In the past, thermoplastic polyolefins have been used in the manufacture of numerous durable products, including vehicle components. A typical thermoplastic polyolefin is a melt blend or reactor blend of a polyolefin plastic, such as polypropylene, which imparts rigidity, and an olefin copolymer elastomer, such as ethylene-propylene rubber, that imparts flexibility. Thermoplastic polyolefins generally have been characterized as blends of a polyolefin plastic in the range of 50-80 weight percent, and elastomer in the range of 20-50 weight percent, which blends yield flexural moduli of between about 40,000 to 180,000 pounds per square inch. Generally speaking, the flexural modulus of a given thermoplastic polyolefin is related to its elastomer content, i.e., the elastomer rubber content in the blend results in a lower flexural modulus, and therefore a more flexible part, while a lower elastomer content results in a higher flexural modulus, and a stiffer part.

In the past, it was known to employ low flexural modulus (i.e., less than 110,000 pounds per square inch) thermoplastic polyolefins to fabricate exterior vehicle components that required painting. Generally speaking, the elastomer content of these thermoplastic polyolefins was greater than 20 weight percent. However, the vehicle components made from these thermoplastic polyolefins suffered from several drawbacks, including low scratch and mar resistance for the finished painted product. Moreover, these low flexural modulus thermoplastic polyolefins are poorly suited for the fabrication of thin-walled vehicle components, and display a tendency towards sag, warp, and distortion during the high temperature (approximately 250° F.) curing cycle necessary for painted vehicle components. High flexural modulus (i.e., greater than about 110,000 pounds per square inch) thermoplastic polyolefins, on the other hand, are known to be difficult to paint as a consequence of their low elastomer content, and are not therefore suited to the fabrication of painted exterior vehicle components.

It would therefore be desirable to provide an economical and effective means for producing exterior vehicle components having good paint adhesion characteristics, while at the same time displaying favorable characteristics in terms of scratch and mar resistance, moldability, and suitability to use as contact parts.

### SUMMARY OF THE INVENTION

In accordance with a first embodiment of the invention, a method for forming a painted exterior component for a vehicle is provided, comprising the steps of: (1) forming the exterior component from a thermoplastic polyolefin comprising polypropylene combined with less than 20 weight percent elastomer, wherein the exterior component has a flexural modulus equal to or greater than about 110,000 pounds per square inch; and (2) painting the exterior component.

In accordance with a second embodiment of the invention, a method for forming a painted exterior component for a vehicle is provided, comprising the steps of: (1) forming the exterior component from a thermoplastic polyolefin comprising polypropylene combined with less than 20 weight percent ethylene-octene copolymer elastomer, wherein the exterior component has a flexural modulus equal to or greater than about 110,000 pounds per square inch; and (2) painting the exterior component.

In accordance with a third embodiment of the invention, a painted exterior component for a vehicle is provided, comprising: (1) an exterior component comprised of a thermoplastic polyolefin comprising polypropylene combined with less than 20 weight percent elastomer, wherein the exterior component has a flexural modulus equal to or greater than about 110,000 pounds per square inch; and (2) a paint deposited on at least a portion of a surface of the exterior component.

In accordance with a fourth embodiment of the invention, a painted exterior component for a vehicle is provided, comprising: (1) an exterior component comprised of a thermoplastic polyolefin comprising polypropylene combined with less than 20 weight percent ethylene-octene copolymer elastomer, wherein the exterior component has a flexural modulus equal to or greater than about 110,000 pounds per square inch; and (2) a paint deposited on at least a portion of a surface of the exterior component.

These and other objects and advantages of the present invention will be better understood with reference to the following detailed description.

### DETAILED DESCRIPTION OF THE INVENTION

The present invention is characterized most generally by the fabrication of a paintable exterior vehicle component using a polypropylene-based thermoplastic polyolefin including an elastomeric, or rubber, component present in an amount less than 20 weight percent, and characterized by a high flexural modulus, preferably equal to or greater than about approximately 110,000 pounds per square inch, and most preferably between about approximately 130,000 pounds per square inch and approximately 170,000 pounds per square inch.

The preferred thermoplastic polyolefin is, most fundamentally, a blend of polypropylene and an elastomeric, or rubber, component that is substantially thermoplastic, and wherein the polypropylene is present, by weight, in an amount of between about more than 50 weight percent, and the elastomer component is present in an amount of less than 20 weight percent, still more preferably in an amount in the range of about 13 to less than 20 weight percent, and most preferably in an amount of about 15 weight percent.

The elastomeric component of the thermoplastic polyolefin preferred for the present invention is preferably produced using metallocene catalysts, and the terms “metallocene elastomer” or “metallocene rubber” as used herein, mean and refer to elastomer or rubber components so prepared.

As used herein, the term “polypropylene” means and refers to any propylene-based polymer having a propylene content equal to or more than about 50 weight percent. The polypropylene may comprise homopolymers, copolymers, or combinations thereof. A preferred copolymer, by way of a non-limiting example, comprises ethylene in an amount less than or equal to about 20 weight percent. The polypropylene comprising the preferred thermoplastic polyolefin of this invention may be formed by bulk liquid polymerization, by way of a non-limiting example, the elastomer or rubber component be added thereafter, for example in a gas phase reactor.

The manner of preparing the preferred thermoplastic polyolefin of the present invention is not thought to be critical to the success of the present invention. Conventional melt blending, reactor blending, combinations thereof, or other means can be employed.

Although the description of the present invention is directed primarily to exterior automobile components, and more specifically wheel flares, it should be appreciated that the compositions of the present invention can be used for fabricating any number of different exterior components that are preferably painted while simultaneously requiring a relatively high flexural modulus.

Accordingly, it will also be appreciated that the present invention is not intended to be limited to automobiles, and that applications for this invention may be made to other vehicles where painted thermoplastic components are incorporated, including, without limitation, watercraft, aircraft, and the like.

In accordance with a non-limiting example, automobile wheel flares were injection-molded, according to known techniques, from the polypropylene-based thermoplastic polyolefin composition produced in accordance with the present invention

During the injection molding process, the preferred material demonstrated a high melt flow relative to conventional materials employed for injection-molded, painted, exterior automobile components, thus facilitating injection molding of parts therefrom. The molded wheel flares were painted, also according to known methods and using known materials. Specifically, an adhesion promoter was applied to the molded part to improve paint adherence thereto. In a preferred embodiment of the present invention, the adhesion promoter included a chlorinated olefin. The adhesion promoter was applied to a thickness of about 0.0003 inches. Of course, other adhesion improving means may be employed, including, by way of a non-limiting example, flame or plasma treatment. Next, a base coat of a desired paint color was applied to a thickness of about 0.0012 inches. Finally, a protective clear coat, by way of a non-limiting example, polyurethane, was applied over the base color coat to a thickness of about 0.0015 inches. The clear coat layer is believed to be important to protect exterior painted automotive components from chemical degradation and physical damage, such as marring and scratching. Following application of the clear coat, the painted wheel flares were cured at 250° F. Of course, it will be understood that other curing methods can be employed.

It will also be appreciated that the particular painting system is not critical to the success of the present invention, and the foregoing methodology is therefore subject to alteration, depending upon various factors.

Cured wheel flares made from a preferred thermoplastic polyolefin material in accordance with the present invention were measured and compared to cured wheel flares formed from EXXPOL ENHANCE PP8224, a readily commercially available polypropylene-based thermoplastic polyolefin marketed by ExxonMobil Chemical Company (Houston, Tex.).

Several of the molded wheel flares were painted for evaluation according to established testing standards applied to exterior automobile components. The tested wheel flares were painted in the following colors: “Ebony,” “Harvest Gold,” “Oxford White,” and “Silver Metallic.” Results of these evaluations are given below in Tables I-VIII, below:

TABLE I

| | | | Present | | Present |
|---|---|---|---|---|---|
| | | | Invention | | Invention |
| | | PP8224 | Composition | PP8224 | Composition |
| | | Ebony | Ebony | Ebony | Ebony |
| | | Wheel Flare | Wheel Flare | Wheel Flare | Wheel Flare |
| Test | Test Method | Sample 1 | Sample 1 | Sample 2 | Sample 2 |
| Paint | FLTM BI | 0 | 0 | 0 | 0 |
| Adhesion | 106-01 | | | | |
| (% Removal) | Method D | | | | |

TABLE II

| | | | Present | | Present |
|---|---|---|---|---|---|
| | | | Invention | | Invention |
| | | PP8224 | Composition | PP8224 | Composition |
| | | Harvest | Harvest | Harvest | Harvest |
| | | Gold Wheel | Gold Wheel | Gold Wheel | Gold Wheel |
| | | Flare | Flare | Flare | Flare |
| Test | Test Method | Sample 1 | Sample 1 | Sample 2 | Sample 2 |
| Paint | FLTM BI | 0 | 0 | 0 | 0 |
| Adhesion | 106-01 | | | | |
| (% Removal) | Method D | | | | |

TABLE III

| | | | Present | | Present |
|---|---|---|---|---|---|
| | | | Invention | | Invention |
| | | PP8224 | Composition | PP8224 | Composition |
| | | Oxford | Oxford | Oxford | Oxford |
| | | White Wheel | White Wheel | White Wheel | White Wheel |
| | | Flare | Flare | Flare | Flare |
| Test | Test Method | Sample 1 | Sample 1 | Sample 2 | Sample 2 |
| Paint | FLTM BI | 0 | 0 | 0 | 0 |
| Adhesion | 106-01 | | | | |
| (% Removal) | Method D | | | | |

TABLE IV

| | | | Present | | Present |
|---|---|---|---|---|---|
| | | | Invention | | Invention |
| | | PP8224 | Composition | PP8224 | Composition |
| | | Silver | Silver | Silver | Silver |
| | | Metallic | Metallic | Metallic | Metallic |
| | | Wheel Flare | Wheel Flare | Wheel Flare | Wheel Flare |
| Test | Test Method | Sample 1 | Sample 1 | Sample 2 | Sample 2 |
| Paint | FLTM BI | 0 | 0 | 0 | 0 |
| Adhesion | 106-01 | | | | |
| (% Removal) | Method D | | | | |

| | | | Present | | Present |
|---|---|---|---|---|---|
| | | | Invention | | Invention |
| | | PP8224 | Composition | PP8224 | Composition |
| | | Ebony | Ebony | Ebony | Ebony |
| | | Wheel Flare | Wheel Flare | Wheel Flare | Wheel Flare |
| Test | Test Method | Sample 1 | Sample 1 | Sample 2 | Sample 2 |
| Water | FLTM BI | Part | Part | Part | Part |
| Resistance | 104- | exhibited | exhibited | exhibited | exhibited no |
| (240 hours | 01/FLTM BI | slight | slight | slight | blistering, no |
| @ 32° C.) | 106-01 | blistering, no | blistering, no | blistering, no | softening, |
| | Method D | softening, | softening, | softening, no | no adhesion |
| | | no adhesion | no adhesion | adhesion | loss, slight |
| | | loss, slight | loss, slight | loss, slight | dulling |
| | | dulling | dulling | dulling | |
| Hydrolysis | FLTM BI | Part | Part | Part | Part |
| Resistance | 106- | exhibited no | exhibited no | exhibited no | exhibited no |
| (% Adhesion | 03/FLTM BI | adhesion | adhesion | adhesion | adhesion |
| Loss) | 106-01 | loss after 14 | loss after 14 | loss after 14 | loss after 14 |
| | Method D | days and | days and | days and | days and |
| | | after 28 | after 28 | after 28 | after 28 |
| | | days under | days under | days under | days under |
| | | test | test | test | test |
| | | conditions | conditions | conditions | conditions |
| Chip | SAE J400 | 7B | 6B | 6B, 8A | 7B |
| Resistance | | | | | |
| (10 pints @ | | | | | |
| 90° C. and | | | | | |
| 23° C.) | | | | | |
| Checking | FLTM BI | Part | Part | Part | Part |
| Resistance | 107-02/ | exhibited no | exhibited no | exhibited no | exhibited no |
| (15 Cycles) | FLTM BI | blistering or | blistering or | blistering or | blistering or |
| | 106-01D | cracking, | cracking, | cracking, | cracking, |
| | Method D | showed no | showed no | showed no | showed no |
| | | adhesion | adhesion | adhesion | adhesion |
| | | loss under | loss under | loss under | loss under |
| | | test | test | test | test |
| | | conditions | conditions | conditions | conditions |
| Thermal | FLTM BI | Part | Part | Part | Part |
| Shock Test | 107-05/ | exhibited no | exhibited no | exhibited no | exhibited no |
| (16 hours at | WSS- | adhesion | adhesion | adhesion | adhesion |
| −40° C./5 | M2P181-A | loss, no | loss, no | loss, no | loss, no |
| minutes at | | distortion | distortion | distortion | distortion |
| 70° C.) | | and no | and no | and no | and no |
| | | cracking | cracking | cracking | cracking |
| Flexibility at | WSS- | Part | Part | Part | Part |
| 23° C. | M2P181-A | exhibited no | exhibited no | exhibited no | exhibited no |
| (50 mm | | cracking | cracking | cracking | cracking |
| Mandrel) | | | | | |
| Heat | WSS- | Part | Part | Part | Part |
| Resistance | M2P181-A/ | exhibited no | exhibited no | exhibited no | exhibited no |
| (7 days at | FLTM BI | adhesion | adhesion | adhesion | adhesion |
| 80° C.) | 106-01 | loss, and | loss, and | loss, and | loss, and |
| | Method D | only slight | only slight | only slight | only slight |
| | | loss of gloss | loss of gloss | loss of gloss | loss of gloss |
| Fuel | FLTM BO | Part | Part | Part | Part |
| Resistance | 101-05/ | exhibited no | exhibited no | exhibited no | exhibited no |
| (Fuel No. 1) | FLTM BI | distortion, | distortion, | distortion, | distortion, |
| | 106-01 | no | no | no | no |
| | Method D | softening, | softening, | softening, | softening, |
| | | no adhesion | no adhesion | no adhesion | no adhesion |
| | | loss, slight | loss, slight | loss, slight | loss, slight |
| | | color | color | color | color |
| | | change, and | change, and | change, and | change, and |
| | | slight dulling | slight dulling | slight dulling | slight dulling |

TABLE VI

| | | | Present | | Present |
|---|---|---|---|---|---|
| | | | Invention | | Invention |
| | | PP8224 | Composition | PP8224 | Composition |
| | | Harvest | Harvest | Harvest | Harvest |
| | | Gold Wheel | Gold Wheel | Gold Wheel | Gold Wheel |
| | | Flare | Flare | Flare | Flare |
| Test | Test Method | Sample 1 | Sample 1 | Sample 2 | Sample 2 |
| Water | FLTM BI | Part | Part | Part | Part |
| Resistance | 104- | exhibited no | exhibited no | exhibited no | exhibited no |
| (240 hours | 01/FLTM BI | blistering, no | blistering, no | blistering, no | blistering, no |
| @ 32° C.) | 106-01 | softening, | softening, | softening, no | softening, |
| | Method D | no adhesion | no adhesion | adhesion | no adhesion |
| | | loss, slight | loss, slight | loss, slight | loss, slight |
| | | dulling | dulling | dulling | dulling |
| Hydrolysis | FLTM BI | Part | Part | Part | Part |
| Resistance | 106- | exhibited no | exhibited no | exhibited no | exhibited no |
| (% Adhesion | 03/FLTM BI | adhesion | adhesion | adhesion | adhesion |
| Loss) | 106-01 | loss after 14 | loss after 14 | loss after 14 | loss after 14 |
| | Method D | days and | days and | days and | days and |
| | | after 28 | after 28 | after 28 | after 28 |
| | | days under | days under | days under | days under |
| | | test | test | test | test |
| | | conditions | conditions | conditions | conditions |
| Chip | SAE J400 | 6B, 7A | 6B, 7A, 8C | 5B, 7A | NA |
| Resistance | | | | | |
| (10 pints @ | | | | | |
| 90° C. and | | | | | |
| 23° C.) | | | | | |
| Checking | FLTM BI | Part | Part | Part | Part |
| Resistance | 107-02/ | exhibited no | exhibited no | exhibited no | exhibited no |
| (15 Cycles) | FLTM BI | blistering or | blistering or | blistering or | blistering or |
| | 106-01D | cracking, | cracking, | cracking, | cracking, |
| | Method D | showed no | showed no | showed no | showed no |
| | | adhesion | adhesion | adhesion | adhesion |
| | | loss under | loss under | loss under | loss under |
| | | test | test | test | test |
| | | conditions | conditions | conditions | conditions |
| Thermal | FLTM BI | Part | Part | Part | Part |
| Shock Test | 107-05/ | exhibited no | exhibited no | exhibited no | exhibited no |
| (16 hours at | WSS- | adhesion | adhesion | adhesion | adhesion |
| −40° C./5 | M2P181-A | loss, no | loss, no | loss, no | loss, no |
| minutes at | | distortion | distortion | distortion | distortion |
| 70° C.) | | and no | and no | and no | and no |
| | | cracking | cracking | cracking | cracking |
| Flexibility at | WSS- | Part | Part | Part | Part |
| 23° C. | M2P181-A | exhibited no | exhibited no | exhibited no | exhibited no |
| (50 mm | | cracking | cracking | cracking | cracking |
| Mandrel) | | | | | |
| Heat | WSS- | Part | Part | Part | Part |
| Resistance | M2P181-A/ | exhibited no | exhibited no | exhibited no | exhibited no |
| (7 days at | FLTM BI | adhesion | adhesion | adhesion | adhesion |
| 80° C.) | 106-01 | loss, and | loss, and | loss, and | loss, and |
| | Method D | only slight | only slight | only slight | only slight |
| | | loss of gloss | loss of gloss | loss of gloss | loss of gloss |
| Fuel | FLTM BO | Part | Part | Part | Part |
| Resistance | 101-05/ | exhibited no | exhibited no | exhibited no | exhibited no |
| (Fuel No. 1) | FLTM BI | distortion, | distortion, | distortion, | distortion, |
| | 106-01 | no | no | no | no |
| | Method D | softening, | softening, | softening, | softening, |
| | | no adhesion | no adhesion | no adhesion | no adhesion |
| | | loss, slight | loss, slight | loss, slight | loss, slight |
| | | color | color | color | color |
| | | change, and | change, and | change, and | change, and |
| | | slight dulling | slight dulling | slight dulling | slight dulling |

TABLE VII

| | | | Present | | Present |
|---|---|---|---|---|---|
| | | | Invention | PP8224 | Invention |
| | | PP8224 | Composition | Harvest | Composition |
| | | Oxford | Oxford | Oxford | Oxford |
| | | White Wheel | White Wheel | White Wheel | White Wheel |
| | | Flare | Flare | Flare | Flare |
| Test | Test Method | Sample 1 | Sample 1 | Sample 2 | Sample 2 |
| Water | FLTM BI | Part | Part | Part | Part |
| Resistance | 104- | exhibited | exhibited | exhibited | exhibited no |
| (240 hours | 01/FLTM BI | slight | slight | slight | blistering, no |
| @ 32° C.) | 106-01 | blistering, no | blistering, no | blistering, no | softening, |
| | Method D | softening, | softening, | softening, no | no adhesion |
| | | no adhesion | no adhesion | adhesion | loss, slight |
| | | loss, slight | loss, slight | loss, slight | dulling |
| | | dulling | dulling | dulling | |
| Hydrolysis | FLTM BI | Part | Part | Part | Part |
| Resistance | 106- | exhibited no | exhibited no | exhibited no | exhibited no |
| (% Adhesion | 03/FLTM BI | adhesion | adhesion | adhesion | adhesion |
| Loss) | 106-01 | loss after 14 | loss after 14 | loss after 14 | loss after 14 |
| | Method D | days and | days and | days and | days and |
| | | after 28 | after 28 | after 28 | after 28 |
| | | days under | days under | days under | days under |
| | | test | test | test | test |
| | | conditions | conditions | conditions | conditions |
| Chip | SAE J400 | 9A | 8B | 6B, 8A | 7A |
| Resistance | | | | | |
| (10 pints @ | | | | | |
| 90° C. and | | | | | |
| 23° C.) | | | | | |
| Checking | FLTM BI | Part | Part | Part | Part |
| Resistance | 107-02/ | exhibited no | exhibited no | exhibited no | exhibited no |
| (15 Cycles) | FLTM BI | blistering or | blistering or | blistering or | blistering or |
| | 106-01D | cracking, | cracking, | cracking, | cracking, |
| | Method D | showed no | showed no | showed no | showed no |
| | | adhesion | adhesion | adhesion | adhesion |
| | | loss under | loss under | loss under | loss under |
| | | test | test | test | test |
| | | conditions | conditions | conditions | conditions |
| Heat | WSS- | Part | Part | Part | Part |
| Resistance | M2P181-A/ | exhibited no | exhibited no | exhibited no | exhibited no |
| (7 days at | FLTM BI | adhesion | adhesion | adhesion | adhesion |
| 80° C.) | 106-01 | loss, and | loss, and | loss, and | loss, and |
| | Method D | only slight | only slight | only slight | only slight |
| | | loss of gloss | loss of gloss | loss of gloss | loss of gloss |
| Fuel | FLTM BO | Part | Part | Part | Part |
| Resistance | 101-05/ | exhibited no | exhibited no | exhibited no | exhibited no |
| (Fuel No. 1) | FLTM BI | distortion, | distortion, | distortion, | distortion, |
| | 106-01 | no | no | no | no |
| | Method D | softening, | softening, | softening, | softening, |
| | | no adhesion | no adhesion | no adhesion | no adhesion |
| | | loss, slight | loss, slight | loss, slight | loss, slight |
| | | color | color | color | color |
| | | change, and | change, and | change, and | change, and |
| | | slight dulling | slight dulling | slight dulling | slight dulling |
| Accelerated | SAE J1960 | Part | Part | Part | Part |
| Weathering | | exhibited no | exhibited no | exhibited no | exhibited no |
| (3000 hours) | | adhesion | adhesion | adhesion | adhesion |
| | | loss, slight | loss, slight | loss, slight | loss, slight |
| | | color | color | color | color |
| | | change, and | change, and | change, and | change, and |
| | | only slight | only slight | only slight | only slight |
| | | loss of gloss | loss of gloss | loss of gloss | loss of gloss |

TABLE VIII

| | | | Present | | Present |
|---|---|---|---|---|---|
| | | | Invention | PP8224 | Invention |
| | | PP8224 | Composition | Harvest | Composition |
| | | Silver | Silver | Silver | Silver |
| | | Metallic | Metallic | Metallic | Metallic |
| | | Wheel Flare | Wheel Flare | Wheel Flare | Wheel Flare |
| Test | Test Method | Sample 1 | Sample 1 | Sample 2 | Sample 2 |
| Water | FLTM BI | Part | Part | Part | Part |
| Resistance | 104- | exhibited | exhibited | exhibited | exhibited |
| (240 hours | 01/FLTM BI | slight | slight | slight | slight |
| @ 32° C.) | 106-01 | blistering, no | blistering, no | blistering, no | blistering, no |
| | Method D | softening, | softening, | softening, no | softening, |
| | | no adhesion | no adhesion | adhesion | no adhesion |
| | | loss, slight | loss, slight | loss, slight | loss, slight |
| | | dulling | dulling | dulling | dulling |
| Hydrolysis | FLTM BI | Part | Part | Part | Part |
| Resistance | 106- | exhibited no | exhibited no | exhibited no | exhibited no |
| (% Adhesion | 03/FLTM BI | adhesion | adhesion | adhesion | adhesion |
| Loss) | 106-01 | loss after 14 | loss after 14 | loss after 14 | loss after 14 |
| | Method D | days and | days and | days and | days and |
| | | after 28 | after 28 | after 28 | after 28 |
| | | days under | days under | days under | days under |
| | | test | test | test | test |
| | | conditions | conditions | conditions | conditions |
| Chip | SAE J400 | 6B, 7A | 8B, 9A | 7B, 7A | 6B, 7A |
| Resistance | | | | | |
| (10 pints @ | | | | | |
| 90° C. and | | | | | |
| 23° C.) | | | | | |
| Checking | FLTM BI | Part | Part | Part | Part |
| Resistance | 107-02/ | exhibited no | exhibited no | exhibited no | exhibited no |
| (15 Cycles) | FLTM BI | blistering or | blistering or | blistering or | blistering or |
| | 106-01D | cracking, | cracking, | cracking, | cracking, |
| | Method D | showed no | showed no | showed no | showed no |
| | | adhesion | adhesion | adhesion | adhesion |
| | | loss under | loss under | loss under | loss under |
| | | test | test | test | test |
| | | conditions | conditions | conditions | conditions |
| Heat | WSS- | Part | Part | Part | Part |
| Resistance | M2P181-A/ | exhibited no | exhibited no | exhibited no | exhibited no |
| (7 days at | FLTM BI | adhesion | adhesion | adhesion | adhesion |
| 80° C.) | 106-01 | loss, and | loss, and | loss, and | loss, and |
| | Method D | only slight | only slight | only slight | only slight |
| | | loss of gloss | loss of gloss | loss of gloss | loss of gloss |
| Fuel | FLTM BO | Part | Part | Part | Part |
| Resistance | 101-05/ | exhibited no | exhibited no | exhibited no | exhibited no |
| (Fuel No. 1) | FLTM BI | distortion, | distortion, | distortion, | distortion, |
| | 106-01 | no | no | no | no |
| | Method D | softening, | softening, | softening, | softening, |
| | | no adhesion | no adhesion | no adhesion | no adhesion |
| | | loss, slight | loss, slight | loss, slight | loss, slight |
| | | color | color | color | color |
| | | change, and | change, and | change, and | change, and |
| | | slight dulling | slight dulling | slight dulling | slight dulling |
| Accelerated | SAE J1960 | Part | Part | Part | Part |
| Weathering | | exhibited no | exhibited no | exhibited no | exhibited no |
| (3000 hours) | | adhesion | adhesion | adhesion | adhesion |
| | | loss, slight | loss, slight | loss, slight | loss, slight |
| | | color | color | color | color |
| | | change, and | change, and | change, and | change, and |
| | | only slight | only slight | only slight | only slight |
| | | loss of gloss | loss of gloss | loss of gloss | loss of gloss |

In current applications, several readily commercially available thermoplastic polyolefins, sold under the trade names SOLVAY D160HS and ESCORENE 8114, are employed for injection-molded, painted exterior vehicle components. Vehicle wheel flares formed from the polypropylene-based thermoplastic polyolefins in accordance with the general teachings of the present invention compare very favorably to identical vehicle components formed from these two conventional thermoplastic polyolefins, as shown in Table IX, below:

TABLE IX

| | | | | Plaque |
|---|---|---|---|---|
| | | | | Shrinkage |
| | | | | (700 psi) |
| | | | Melt Flow | after |
| | | Rockwell | (gram/10 | curing |
| Material | Flexural Modulus | Hardness | minutes) | at 250° F. |
| SOLVAY | 80,000 pounds | 2 | 9.8 | 0.015 |
| D160HS | per square inch | | | |
| ESCORENE | 140,000 pounds | 60 | 25 | 0.015 |
| 8114 | per square inch | | | |
| Polypropylene- | 130,000 pounds | 50 | 23 | 0.015 |
| based | per square inch | | | |
| thermoplastic | | | | |
| polyolefin | | | | |
| produced in | | | | |
| accordance with | | | | |
| the general | | | | |
| teachings of the | | | | |
| present invention | | | | |
| (e.g., 13 weight | | | | |
| percent ethylene- | | | | |
| octene copolymer | | | | |
| elastomer) | | | | |

It will be understood from this disclosure that the inventors have discovered an economical and highly useful substitute for conventional thermoplastic polyolefins in the area of painted exterior vehicle components, which is at once suitable for painting, while also producing components of a desirable stiffness.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents may be resorted to that fall within the scope of the invention as defined in the following claims.

What is claimed is:

1. A method for forming a painted exterior component for a vehicle, comprising the steps of:
forming the exterior component from a thermoplastic polyolefin comprising polypropylene combined with less than 20 weight percent elastomer, wherein the exterior component has a flexural modulus equal to or greater than about 110,000 pounds per square inch; and
painting the exterior component.

2. The invention according to claim 1, wherein the flexural modulus of the thermoplastic polyolefin is between about 130,000 pounds per square inch and about 170,000 pounds per square inch.

3. The invention according to claim 1, wherein the elastomer is present in an amount in the range of about 13 to less than 20 weight percent.

4. The invention according to claim 1, wherein the elastomer is present in an amount of about 15 weight percent.

5. The invention according to claim 1, wherein the elastomer comprises an ethylene-octene copolymer.

6. The invention according to claim 1, wherein the elastomer is formed with a metallocene catalyst.

7. A method for forming a painted exterior component for a vehicle, comprising the steps of:
forming the exterior component from a thermoplastic polyolefin comprising polypropylene combined with less than 20 weight percent ethylene-octene copolymer elastomer, wherein the exterior component has a flexural modulus equal to or greater than about 110,000 pounds per square inch; and
painting the exterior component.

8. The invention according to claim 7, wherein the flexural modulus of the thermoplastic polyolefin is between about 130,000 pounds per square inch and about 170,000 pounds per square inch.

9. The invention according to claim 7, wherein the elastomer is present in an amount in the range of about 13 to less than 20 weight percent.

10. The invention according to claim 7, wherein the elastomer is present in an amount of about 15 weight percent.

11. The invention according to claim 7, wherein the elastomer is formed with a metallocene catalyst.

12. A painted exterior component for a vehicle, comprising:
an exterior component comprised of a thermoplastic polyolefin comprising polypropylene combined with less than 20 weight percent elastomer, wherein the exterior component has a flexural modulus equal to or greater than about 110,000 pounds per square inch; and
a paint deposited on at least a portion of a surface of the exterior component.

13. The invention according to claim 12, wherein the flexural modulus of the thermoplastic polyolefin is between about 130,000 pounds per square inch and about 170,000 pounds per square inch.

14. The invention according to claim 12, wherein the elastomer is present in an amount in the range of about 13 to less than 20 weight percent.

15. The invention according to claim 12, wherein the elastomer is present in an amount of about 15 weight percent.

16. The invention according to claim 12, wherein the elastomer comprises an ethylene-octene copolymer.

17. The invention according to claim 12, wherein the elastomer is formed with a metallocene catalyst.

18. A painted exterior component for a vehicle, comprising:
an exterior component comprised of a thermoplastic polyolefin comprising polypropylene combined with less than 20 weight percent ethylene-octene copolymer elastomer, wherein the exterior component has a flexural modulus equal to or greater than about 110,000 pounds per square inch; and
a paint deposited on at least a portion of a surface of the exterior component.

19. The invention according to claim 18, wherein the flexural modulus of the thermoplastic polyolefin is between about 130,000 pounds per square inch and about 170,000 pounds per square inch.

20. The invention according to claim 18, wherein the elastomer is present in an amount in the range of about 13 to less than 20 weight percent.

21. The invention according to claim 18, wherein the elastomer is present in an amount of about 15 weight percent.

22. The invention according to claim 18, wherein the elastomer is formed with a metallocene catalyst.
